(19) United States
(12) Patent Application Publication
(10) Pub. No.: US 2009/0282443 A1
(43) Pub. Date: Nov. 12, 2009

(54) STREAMING METHOD AND APPARATUS USING KEY FRAME

(75) Inventor: Tae-jeoung Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/436,332

(22) Filed: May 6, 2009

Related U.S. Application Data
(60) Provisional application No. 61/051,140, filed on May 7, 2008.

(30) Foreign Application Priority Data
Jan. 28, 2009 (KR) 10-2009-0006613

(51) Int. Cl. H04N 7/173; H04N 11/04

(52) U.S. Cl. 725/88; 375/240.13; 725/91; 725/100; 375/E07.026

(57) ABSTRACT

Provided is a streaming method and apparatus using key frames, the streaming method including: receiving from a key frame providing server a key frame table including metadata regarding a plurality of key frames of content based on a request of a client device; receiving a fast forward instruction or a fast rewind instruction; and requesting a content providing device that stores the content for a key frame corresponding to a fast forward reproduction point or a fast rewind reproduction point.

This application claims the benefit of U.S. Provisional Application No. 61/051,140, filed on May 7, 2008, in the U.S. Patent & Trademark Office, and Korean Patent Application No. 10-2009-0006613, filed on Jan. 28, 2009, in the Korean Intellectual Property Office, the disclosures of which are incorporated herein in their entirety by reference.

### BACKGROUND OF THE INVENTION

1. Field of the Invention

Methods and apparatuses consistent with the present invention relate to a streaming and using a key frame, and more particularly, to a streaming apparatus and method using a key frame so as to provide various reproduction services, such as fast forward and fast rewind, by using peer-to-peer streaming or server streaming.

2. Description of the Related Art

Video on demand (VOD) systems are bidirectional systems for allowing users to select and watch/listen to video or audio content, such as movies, education programs, games, and shopping channels, on demand through communication networks.

VOD systems provide users with very low-quality video content due to the limited Internet speed and the performance of a content providing server when the number of connected terminals increases. Thus, peer-to-peer (P2P) streaming technology has been recently developed by which terminals communicate necessary content packets with each other.

In the P2P streaming technology, a client device receives a list of a content providing device which stores corresponding content from a metadata providing server which provides the list of the content providing device. The client device requests a specific content providing device for content and receives from the specific content providing device the content in the list of the content providing device according to a predetermined priority.

The P2P streaming technology makes it possible to transmit high-quality content and does not provide a variety of reproduction services, such as fast forward or fast rewind, as by a conventional content providing server.

### SUMMARY OF THE INVENTION

Exemplary embodiments of the present invention provide a streaming apparatus and method using a key frame so as to provide various reproduction services, such as fast forward and fast rewind, by using peer-to-peer streaming.

According to an exemplary aspect of the present invention, there is provided a streaming method using key frames, the streaming method including: receiving from a key frame providing server a key frame table including metadata regarding a plurality of key frames of content based on a request of a client device; receiving a fast forward instruction or a fast rewind instruction; and requesting a content providing device that stores the content for a key frame corresponding to a fast forward reproduction point or a fast rewind reproduction point.

The plurality of key frames may be buffered by a key frame buffer which is separate from a general frame buffer for buffering general frames other than the plurality of key frames.

The streaming method may further include: recombining and reproducing the key frames buffered by the key frame buffer during a normal-speed forward operation or a normal-speed rewind operation.

The method may further include: receiving from the key frame providing server a list of the content providing device that stores the content based on the request of the client device.

A moving pictures experts group (MPEG) intra-coded (I) frame may be included in the plurality of key frames.

The key frame providing server and the content providing device may be integrated or are separated from each other.

According to another exemplary aspect of the present invention, there is provided a method of providing a key frame, the method including: generating a key frame table including metadata regarding a plurality of key frames of content; and transmitting the key frame table regarding the content to a client device based on a request of the client device.

The generating of the key frame table may include: parsing a file format of the content; extracting the plurality of key frames from parsed data; and converting the plurality of key frames in a predetermined metadata format.

The metadata format may include an eXtensible Markup Language (XML) metadata format.

The method may further include: transmitting a list of content providing device that stores the content to the client device based on a request of a client device.

An MPEG I frame may be included in the plurality of key frames.

According to another exemplary aspect of the present invention, there is provided a computer readable recording medium storing a program for executing the method.

According to another exemplary aspect of the present invention, there is provided a client device using key frames, the client device including: a receiving unit receiving from a key frame providing server a key frame table including metadata regarding a plurality of key frames of content based on a request of the client device; an interface unit receiving a fast forward instruction or a fast rewind instruction; and a key frame request unit requesting a content providing device that stores the content for a key frame corresponding to a fast forward reproduction point or a fast rewind reproduction point.

According to another exemplary aspect of the present invention, there is provided a server device for providing a key frame, the server device including: a key frame table generating unit generating a key frame table including metadata regarding a plurality of key frames of content; and a transmitting unit transmitting the key frame table regarding the content to a client device based on a request of the client device.

### BRIEF DESCRIPTION OF THE DRAWINGS

The above and other features and aspects of the present invention will become more apparent by describing in detail exemplary embodiments thereof with reference to the attached drawings in which:

FIG. 1 is a schematic dataflow diagram of a streaming service using a key frame, according to an exemplary embodiment of the present invention;

FIG. 2 is a schematic dataflow diagram of a streaming service using a key frame, according to another exemplary embodiment of the present invention;

FIG. 3 illustrates a frame type of content, according to an exemplary embodiment of the present invention;

FIG. 4 is a flowchart illustrating a process of providing key frames according to an exemplary embodiment of the present invention;

FIG. 5 is a flowchart illustrating a process of generating key frames according to an exemplary embodiment of the present invention;

FIG. 6 illustrates a content file format according to an exemplary embodiment of the present invention;

FIG. 7 is a flowchart illustrating a streaming process using key frames, according to an exemplary embodiment of the present invention;

FIG. 8 illustrates double buffers used by client devices, according to another exemplary embodiment of the present invention;

FIG. 9 is a block diagram of a server device for providing key frames according to an exemplary embodiment of the present invention; and

FIG. 10 is a block diagram of a client device using key frames, according to an exemplary embodiment of the present invention;

### DETAILED DESCRIPTION OF THE INVENTION

Exemplary embodiments of the present invention will now be described more fully hereinafter with reference to the accompanying drawings, in which exemplary embodiments of the invention are shown. Like reference numerals denote like elements throughout. In the drawings, the thicknesses of layers and regions are exaggerated for clarity.

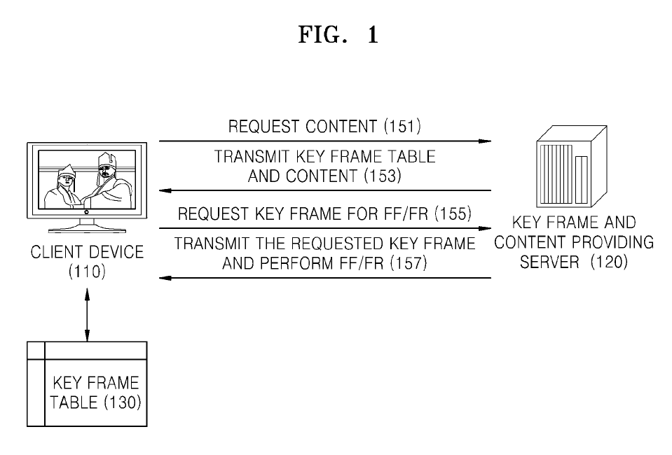

FIG. 1 is a schematic dataflow diagram of a streaming service using a key frame, according to an exemplary embodiment of the present invention.

Referring to FIG. 1, in operation 151, a client device 110 requests a key frame and content providing server 120 for content.

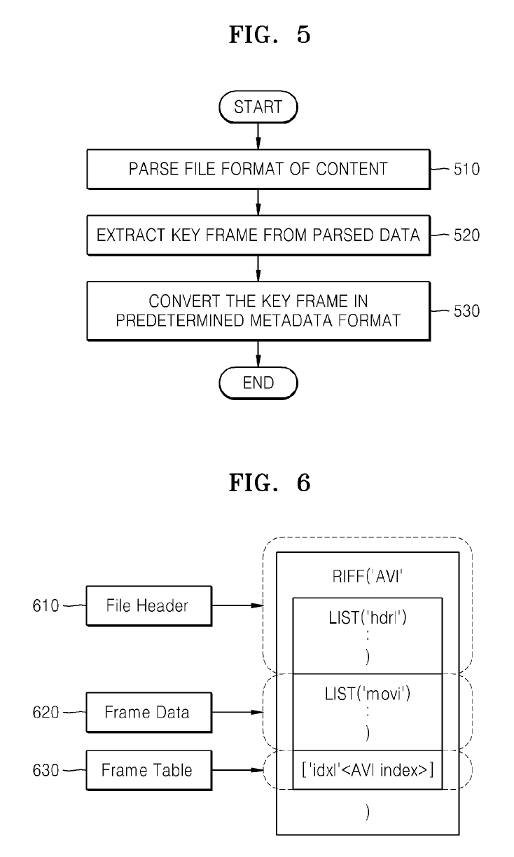

In operation 153, the client device 110 receives a key frame table 130 from the key frame and content providing server 120 and receives the content in the form of packets. The key frame table 130 includes metadata regarding key frames of content. The key frame and content providing server 120 preprocesses and generates the key frame table 130 when registering the content. An operation of generating the key frame table 130 will be described in detail with reference to FIG. 5.

In operation 155, the client device 110 requests the key frame and content providing server 120 for a key frame corresponding to a fast forward reproduction point or a fast rewind reproduction point.

In operation 157, the client device 110 receives the requested key frame in the form of packets from the key frame and content providing server 120 and performs fast forward or fast rewind.

According to the present embodiment, the client device 110 receives the key frame table 130, in which the key frame regarding the content is previously analyzed at the time for resuming reproduction of the content, from the key frame and content providing server 120 and directly determines the key frame required at the fast forward reproduction point or the fast rewind reproduction point, thereby distributing a processing load of the key frame and content providing server 120, which is required at the fast forward reproduction point or the fast rewind reproduction point of the content with regard to the key frame, to the client device 110.

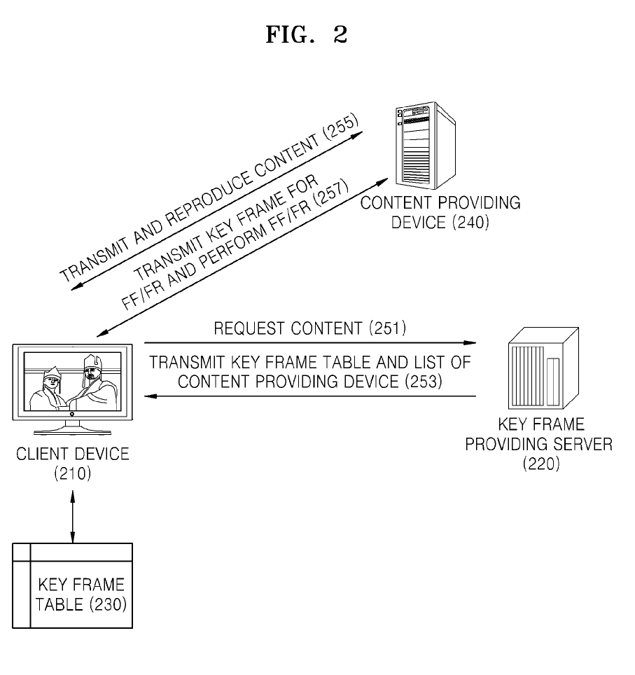

FIG. 2 is a schematic dataflow diagram of a streaming service using a key frame, according to another exemplary embodiment of the present invention. Referring to FIG. 2, a content providing device 240 and a key frame providing server 220 are physically separated from each other. Therefore, the key frame providing server 220 manages a key frame table 230 and information about a list of a content providing device 240, and a client device 210 receives content from the content providing device 240 through P2P streaming and reproduces the content.

In more detail, in operation 251, the client device 210 requests the key frame providing server 220 for content.

In operation 253, the client device 210 receives from the key frame providing server 220 the key frame table 230 and the list of the content providing device 240 that stores the content. The key frame table 230 includes metadata regarding key frames of content. The key frame providing server 220 preprocesses and generates the key frame table 230 when registering the content. An operation of generating the key frame table 230 will be described in detail with reference to FIG. 5.

In operation 255, the client device 210 requests the content providing device 240 for content and receives from the content providing device 240 the content in the list of the content providing device 240 according to a predetermined priority.

In operation 257, the client device 210 receives fast forward or fast rewind instruction, i.e., a fast forward or a fast rewind command, from the outside and requests the content providing device 240 for a key frame corresponding to a fast forward reproduction point or a fast rewind reproduction point. The client device 210 receives the key frame in the form of packets and performs fast forward or fast rewind.

According to the present embodiment, the client device 210 receives the key frame table 230, in which the key frame regarding the content is previously analyzed, and the list of the content providing device 240 from the key frame providing server 220 and receives the content from a content providing device 240 through the P2P streaming, thereby avoiding congestion in a content providing server and transmitting high-quality content.

The client device 210 may receive various reproduction services, such as fast forward or fast rewind, while achieving the merit of the P2P streaming by using the key frame table 230 received from the key frame providing server 220.

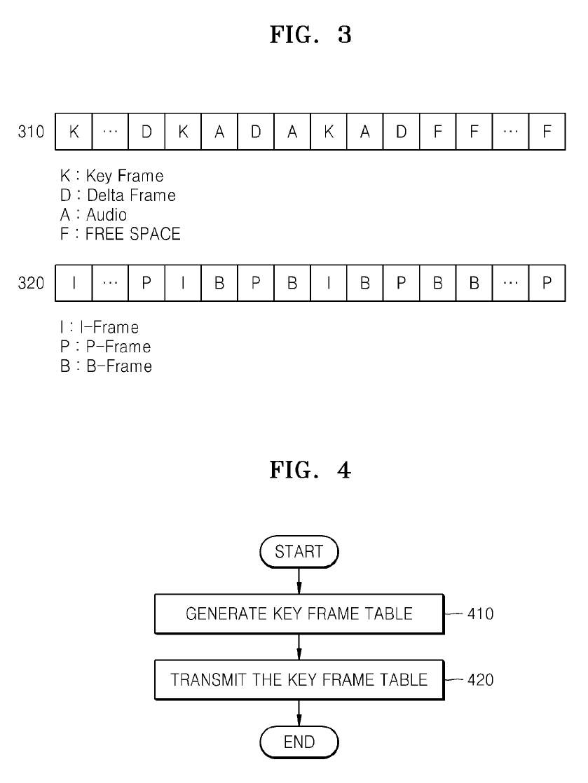

FIG. 3 illustrates a frame type 310 of content, according to an exemplary embodiment of the present invention. Referring to FIG. 3, although the frame type 310 of content is compared to a moving pictures experts group (MPEG) group of pictures (GOP) structure 320, one of ordinary skill in the art can also compare the frame type 310 of content to another standard specification.

The MPEG GOP structure 320 is a frame group including at least one intra-coded (I) frame which includes coding information in a frame, and generally includes 10 through 30 frames.

The I frame includes encoded image information of a corresponding frame. A predictive (P) frame and a bidirectionally predictive coded (B) frame include encoded information about frames other than a corresponding frame. The P frame includes information about an inside image and forward predictive information. The B frame includes information about an inside image, forward predictive information, backward predictive information, and bidirectionally predictive information.

A key frame of content corresponds to an MPEG I frame, and includes reproducible image information from a corresponding frame.

A delta frame of content corresponds to an MPEG P frame and a B frame, and is encoded with reference to information about frames other than a corresponding frame.

The key frame includes the reproducible image information from a corresponding frame and thus its size is large. Thus, in order to increase the compressibility of content, the content may include a very limited number of key frames and a large number of delta frames between the key frames.

In the present embodiment, in order to provide a fast forward service or a fast rewind service, the key frame and content providing server 120 or the key frame providing server 220 preprocess and generate the key frame tables 130 or 230 including the metadata regarding the key frames of content when registering the content.

FIG. 4 is a flowchart illustrating a process of providing key frames according to an exemplary embodiment of the present invention.

Referring to FIG. 4, in operation 410, the key frame and content providing server 120 or the key frame providing server 220 generates the key frame tables 130 or 230 including metadata regarding key frames of content. Although an MPEG I frame is included in the key frames in the present embodiment, it is obvious to one of ordinary skill in the art that an I frame defined by another standard specification may be included in the key frames.

In operation 420, the key frame and content providing server 120 and the key frame providing server 220 transmits the key frame tables 130 and 230 regarding the content to the client devices 110 and 210 based on the request of the client devices 110 and 210, respectively.

FIG. 5 is a flowchart illustrating a process of generating key frames according to an exemplary embodiment of the present invention.

Referring to FIG. 5, in operation 510, the key frame and content providing server 120 or the key frame providing server 220 parses a content file format.

In operation 520, the key frame and content providing server 120 or the key frame providing server 220 extracts a key frame from the parsed data.

In operation 530, the key frame and content providing server 120 or the key frame providing server 220 converts the key frame in a predetermined metadata format. Although an eXtensible Markup Language (XML) metadata format is used as the metadata format in the present embodiment, it is obvious to one of ordinary skill in the art that another format may be used as the metadata format.

FIG. 6 illustrates a content file format according to an exemplary embodiment of the present invention. Referring to FIG. 6, although an audio video interleave (AVI) format is used as the content file format in the present embodiment, it is obvious to one of ordinary skill in the art that another multimedia format may be used as the content file format.

The content file format includes a file header 610, frame data 620, and a frame table 630. The file header 610 includes information indicating that the content file format is the AVI format. The frame data 620 includes motion picture frames. The frame table 630 includes metadata corresponding to the frame data 620 in a table format. The detailed description of the AVI format is omitted here.

The key frame and content providing server 120 and the key frame providing server 220 parse various multimedia formats, such as the AVI format, extract and convert a key frame as described in the method of FIG. 5, and preprocess and generate the key frame tables 130 and 230 independent from a specific multimedia format when registering the content, respectively. The key frame tables 130 and 230 may be used for various reproduction services, such as fast forward or fast rewind.

The key frame tables 130 and 230 generated by using the XML metadata format are described below. Although the XML metadata format is used as a key frame conversion format in the present embodiment, it is obvious to one of ordinary skill in the art that another conversion format may be used as the key frame conversion format.

```
<KeyFrame>
  <index>001</index>
  <FilePosition>2350</FilePosition>
  <PlayTime>10000</Playtime>
</KeyFrame>
<KeyFrame>
  <index>002</index>
  <FilePosition>2360</FilePosition>
  <PlayTime>11000</Playtime>
</KeyFrame>
...
```

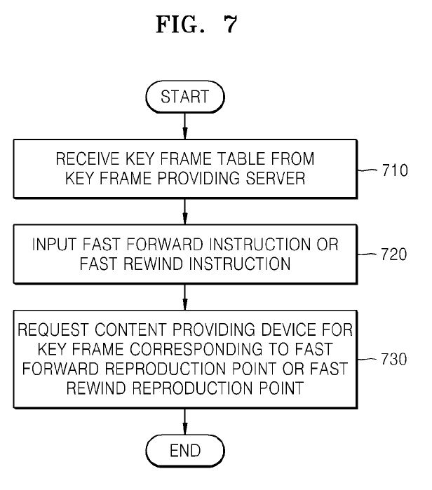

FIG. 7 is a flowchart illustrating a streaming process using key frames, according to an exemplary embodiment of the present invention.

Referring to FIG. 7, in operation 710, the client device 110 receives from the key frame and content providing server 120 a key frame table including metadata regarding the key frames of content. Although an MPEG I frame is included in the key frames in the present embodiment, it is obvious to one of ordinary skill in the art that an I frame defined by another standard specification may be included in the key frames.

In operation 720, the client device 110 receives a fast forward instruction or a fast rewind instruction from an external device or a user.

In operation 730, the client device 110 requests the key frame and content providing server 120 for a key frame corresponding to a fast forward reproduction point or a fast rewind reproduction point.

Although the client device 110 receives from the key frame and content providing server 120 the key frame table and the content in the present embodiment, the client device 100 may receive the key frame table and a list of the content providing device 240 from the key frame providing server 220 and receive the content from the content providing device 240 according to another embodiment.

Alternatively, in operation 710, the client server 210 receives from the key frame providing server 220 the key frame table including the metadata regarding the key frames of content and the list of the content providing device 240 that stores the content.

In operation 720, the client device 210 receives the fast forward instruction or the fast rewind instruction based on an external input.

In operation 730, the client device 210 requests the content providing device 240 in the list of the content providing device 240 according to a predetermined priority for the key frame corresponding to the fast forward reproduction point or the fast rewind reproduction point.

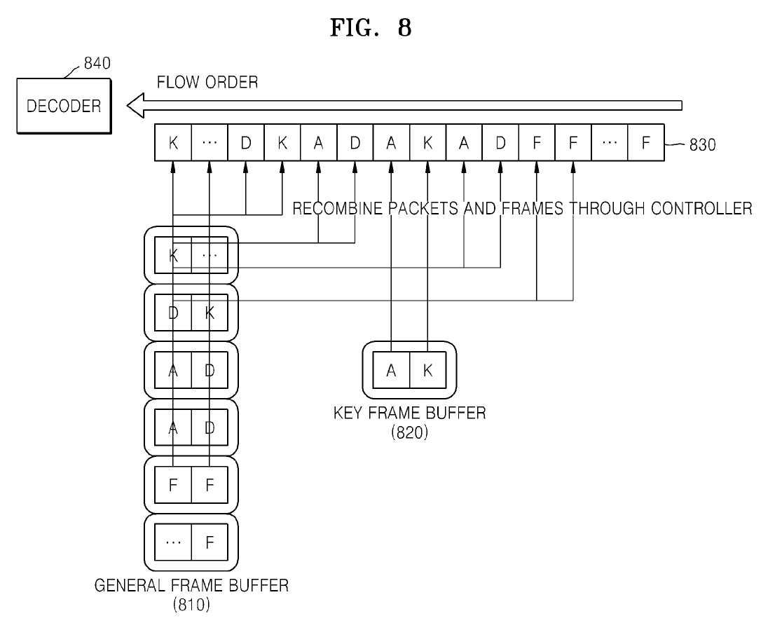

FIG. 8 illustrates double buffers used by the client devices 110 and 210, according to another exemplary embodiment of the present invention. Referring to FIG. 8, the client devices 110 and 210 separately use a key frame buffer for buffering a key frame and a general frame buffer for buffering a general frame other than the key frame.

When the client devices 110 and 210 receive key frames from the key frame and content providing server 120 and the content providing device 240 during a fast forward operation or a fast rewind operation, respectively, the client devices 110 and 210 reproduce the key frames by extracting and recombining the key frames buffered by the key frame buffer without needing to receive the already received key frames during a normal-speed forward operation or a normal-speed rewind operation.

In more detail, the key frames received from the key frame buffer may be used to perform the normal-speed forward operation or the normal-speed rewind operation and the fast forward operation or the fast rewind operation.

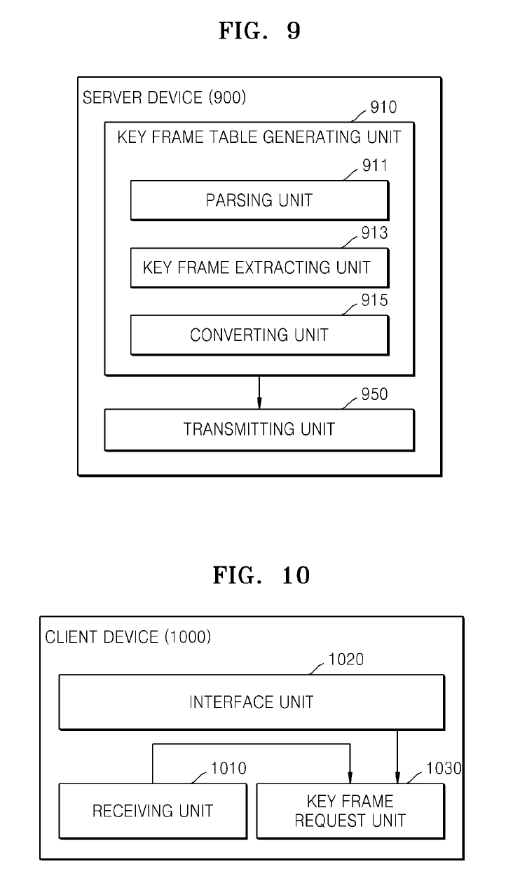

FIG. 9 is a block diagram of a server device 900 for providing key frames according to an exemplary embodiment of the present invention. Referring to FIG. 9, the server device 900 includes a key frame table generating unit 910 and a transmitting unit 950.

The key frame table generating unit 910 generates a key frame table including metadata regarding the key frames of content. Although an MPEG I frame is included in the key frames in the present embodiment, it is obvious to one of ordinary skill in the art that an I frame defined by another standard specification may be included in the key frames. The key frame table generating unit 910 includes a parsing unit 911, a key frame extracting unit 913, and a converting unit 915 so as to generate the key frame table.

The parsing unit 911 parses a content file format. The key frame extracting unit 913 extracts the key frames from parsed data. The converting unit 915 converts the key frames to a predetermined metadata format. Although an XML metadata format is used as the metadata format in the present embodiment, it is obvious to one of ordinary skill in the art that another format may be used as the metadata format.

The transmitting unit 950 transmits the key frame table regarding the content to the client device 210 based on a request of the client device 210.

Alternatively, the server device 900 may transmit to the client device 210 a list of the content providing device 240 that stores the content and the key frame table. In this case, the transmitting unit 950 may transmit to the client device 210 the key frame table regarding the content and the list of the content providing device 240 that stores the content based on the request of the client device 210.

FIG. 10 is a block diagram of a client device 1000 using key frames, according to an exemplary embodiment of the present invention. Referring to FIG. 10, the client device 1000 includes a receiving unit 1010, an interface unit 1020, and a key frame request unit 1030.

The receiving unit 1010 receives from the key frame and content providing server 120 a key frame table including metadata regarding the key frames of content. Although an MPEG I frame is included in the key frames in the present embodiment, it is obvious to one of ordinary skill in the art that an I frame defined by another standard specification may be included in the key frames.

The interface unit 1020 receives a fast forward instruction or a fast rewind instruction from an external device or a user.

The key frame request unit 1030 requests the key frame and content providing server 120 that stores the content for a key frame corresponding to a fast forward reproduction point or a fast rewind reproduction point.

Although the client device 1000 may receive from the key frame and content providing server 120 the key frame table and the content in the present embodiment, the client device 1000 may receive from the key frame providing server 220 the key frame table and a list of the content providing device 240 and receive the content from the content providing device 240 according to another embodiment.

Alternatively, the receiving unit 1010 receives from the key frame providing server 220 the key frame table including the metadata regarding the key frames of content and the list of the content providing device that stores the content.

The interface unit 1020 receives the fast forward instruction or the fast rewind instruction from an external device or a user.

The key frame request unit 1030 requests the content providing device 240 for the key frame corresponding to the fast forward reproduction point or the fast rewind reproduction point in the list of a content providing device according to a predetermined priority.

The client devices 110 and 210 separately use a key frame buffer for buffering a key frame and a general frame buffer for buffering a general frame other than the key frame, according to another embodiment.

When the client devices 110 and 210 receive key frames from the key frame and content providing server 120 or the content providing device 240, during a fast forward operation or a fast rewind operation, a reproduction unit (not shown) of the client device 1000 generates the key frame by extracting and recombining the key frames buffered by the key frame buffer without needing to receive the already received key frames during a normal-speed forward operation or a normal-speed rewind operation.

Exemplary embodiments of the present invention can also be embodied as computer readable code on a computer readable recording medium. The computer readable recording medium is any data storage device that can store data which can be thereafter read by a computer system.

Examples of the computer readable recording medium include read-only memory (ROM), random-access memory (RAM), CD-ROMs, magnetic tapes, floppy disks, optical data storage devices, etc.

While exemplary embodiments of the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A streaming method using key frames, the streaming method comprising:
receiving from a server a key frame table including metadata regarding a plurality of key frames of a content, based on a request of a client device;
receiving a fast forward command or a fast rewind command; and
requesting a device that stores the content for a key frame of the plurality of key frames, corresponding to a fast forward reproduction point or a fast rewind reproduction point.

2. The streaming method of claim 1, wherein the plurality of key frames are buffered by a key frame buffer which is separate from a general frame buffer for buffering general frames other than the plurality of key frames.

3. The streaming method of claim 2, further comprising:
recombining and reproducing the plurality of key frames buffered by the key frame buffer during a normal-speed forward operation or a normal-speed rewind operation.

4. The method of claim 1, further comprising: receiving from the server a list of the device that stores the content, based on the request of the client device.

5. The streaming method of claim 1, wherein a moving pictures experts group (MPEG) intra-coded (I) frame is included in the plurality of key frames.

6. The streaming method of claim 1, wherein the server and the device that stores the content, are integrated or are separated from each other.

7. A method of providing a key frame, the method comprising:
generating a key frame table including metadata regarding a plurality of key frames of content; and
transmitting the key frame table to a client device based on a request of the client device.

8. The method of claim 7, wherein the generating of the key frame table comprises:
parsing a file format of the content to generate parsed data;
extracting the plurality of key frames from the parsed data; and
converting the plurality of key frames into a predetermined metadata format.

9. The method of claim 8, wherein the metadata format includes an eXtensible Markup Language (XML) metadata format.

10. The method of claim 7, further comprising: transmitting a list of a device that stores the content, to the client device based on the request of the client device.

11. The method of claim 7, wherein an MPEG I frame is included in the plurality of key frames.

12. A client device using key frames, the client device comprising:
a receiving unit which receives from a server a key frame table including metadata regarding a plurality of key frames of content, based on a request of the client device;
an interface unit which receives a fast forward command or a fast rewind command; and
a key frame request unit which requests a device that stores the content for a key frame corresponding to a fast forward reproduction point or a fast rewind reproduction point.

13. The client device of claim 12, wherein the plurality of key frames are buffered by a key frame buffer which is separate from a general frame buffer for buffering general frames other than the plurality of key frames.

14. The client device of claim 13, further comprising: a reproduction unit which recombines and reproduces the key frames buffered by the key frame buffer during a normal-speed forward operation or a normal-speed rewind operation.

15. The client device of claim 12, wherein the receiving unit receives from the server a list of the device that stores the content, based on the request of the client device.

16. The client device of claim 12, wherein an MPEG I frame is included in the plurality of key frames.

17. The client device of claim 13, wherein the server and the device that stores the content, are integrated or are separated from each other.

18. A server device for providing a key frame, the server device comprising:
a key frame table generating unit which generates a key frame table including metadata regarding a plurality of key frames of content; and
a transmitting unit which transmits the key frame table to a client device based on a request of the client device.

19. The server device of claim 18, wherein the key frame table generating unit comprises:
a parsing unit which parses a file format of the content to generated parsed data;
a key frame extracting unit which extracts the plurality of key frames from the parsed data; and
a converting unit which converts the plurality of key frames into a predetermined metadata format.

20. The server device of claim 19, wherein the metadata format includes an XML metadata format.

21. The server device of claim 18, wherein the transmitting unit transmits a list of a device that stores the content, to the client device based on the request of the client device.

22. The server device of claim 18, wherein an MPEG I frame is included in the plurality of key frames.

23. A computer readable recording medium storing a program for executing the method of claim 1.

24. A computer readable recording medium storing a program for executing the method of claim 7.

25. A method of streaming comprising:
receiving one of a fast forward command and a fast rewind command;
transmitting a request to a server;
receiving from the server, a table including information regarding a plurality of frames of a content, based on the request;
requesting the server or a content transmitting device for a frame of the plurality of frames, corresponding to one of the fast forward and the fast rewind commands.

26. The method of claim 25, wherein the requesting comprises requesting the server for the frame of the plurality of frames, and the frame of the plurality of frames includes an MPEG I frame.

27. The method of claim 26, wherein the requesting comprises requesting the content transmitting device for the frame of the plurality of frames, and the frame of the plurality of frames includes an MPEG I frame.
